(19) United States
(12) Patent Application Publication
(10) Pub. No.: US 2009/0192897 A1
(43) Pub. Date: Jul. 30, 2009

(54) PROACTIVE IDENTIFICATION OF TARGETS FOR ADVERTISEMENTS

(75) Inventors: Nathan Dintenfass, San Francisco, CA (US); David Mclntosh, Del Mar, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Redux, Inc., Berkeley, CA (US)

(21) Appl. No.: 12/360,069

(22) Filed: Jan. 26, 2009

Related U.S. Application Data
(60) Provisional application No. 61/023,769, filed on Jan. 25, 2008.

(51) Int. Cl. G06Q 30/00; G06Q 90/00

(52) U.S. Cl. 705/14

(57) ABSTRACT

Methods and systems are provided that allow advertisers to custom define questions that are delivered to people through a digital media experience. Subsequent to answering the questions, consumers are shown advertisements based on their answers to one or more of the questions.

### CROSS-REFERENCES TO RELATED APPLICATIONS

The present patent application claims priority from the commonly assigned U.S. provisional patent application No. 61/023,769 entitled “PROACTIVE TARGET IDENTIFICATION” by Nathan Dintenfass et al. (Atty. Docket No. 026909-000500US) filed Jan. 25, 2008 and is related to commonly owned U.S. patent application Ser. No. 12/247,947, entitled “System and Method for Advertising Using Image Recognition Inventors,” by David McIntosh et al. (Atty. Docket No. 026909-000310US), both of which are incorporated by reference for all purposes.

### BACKGROUND

The present invention is generally related to providing targeted advertisements, and more specifically to proactively acquiring information on behalf of advertisers to use in selecting a targeted advertisement.

Advertisements are a ubiquitous part of a person's everyday life. As one walks down a street, there are billboards and signs everywhere. A person's regular mailbox is often filled with multiple solicited or unsolicited mail everyday. Also, the proliferation of electronic advertising is even more abundant. People encounter many online ads, such as pop-up ads, banner ads, plain text ads, and e-mail ads.

Given that a person is inundated with so much advertising, a person may become desensitized to advertising, which can decrease the impact that a business can have when attempting to market a product. The business may end up just placing more and varied advertisements in attempt that the person will finally take notice after seeing an advertisement so many times. However, such over-advertising is wasteful, inefficient, costly, and may end up alienating the consumer.

Furthermore, even when an advertisement is targeted, the information used to target the advertisement is usually not very helpful. The information, which has typically been collected previously and stored in a database, may be irrelevant to the advertiser, or at least of tangential importance. Even when the existing information is relevant for targeting an advertisement, the information is not something an advertiser can control. The advertiser can use only the information already available and must hope that information matches with their targeting needs.

Therefore, what is needed are improved systems, apparatus, and methods for providing targeted advertisements.

### BRIEF SUMMARY

Embodiments provide improved methods, apparatus, and systems for providing targeted advertisements (ads) that are highly relevant to a particular person or portion of the population. Once a person is identified as being relevant to a specific good, service, or provider of goods and services (e.g. through specific questions and answers), an advertiser can send targeted advertisements to that person.

In one aspect, advertisers can custom define questions that are delivered to an electronic device being used by a consumer. Subsequent to answering the questions, consumers are shown advertisements based on their answers to one or more of the questions. Unlike other advertisement targeting approaches that use extant (existing) consumer data to target advertisements, such a proactive target identification method allows advertisers to define, up-front, questions to elicit a certain response and then base the advertisement on the response.

According to an exemplary embodiment, a method of providing a targeted advertisement to a consumer is provided. A target identification system receives, from an advertiser, an identification of one or more questions to be provided to a consumer, and one or more answers corresponding to a particular one or more advertisements that are to be provided to the consumer. At least one of the identified questions is sent from the target identification system to an electronic device of a consumer. The target identification system receives, from the consumer, one or more responses to the at least one question. The responses are compared to the identified answers. Based on the comparison of the responses to the identified answers, at least one of the particular advertisements is provided to the consumer.

According to an exemplary embodiment, a proactive target identification and advertising system is provided. An interface allows an advertiser to identify one or more questions to be provided to a consumer and one or more answers corresponding to a particular one or more advertisements that are to be provided to the consumer. One or more processors configured to: send at least one of the identified questions from the target identification system to an electronic device of a consumer; receive, at the target identification system from the consumer, one or more responses to the at least one question; compare the responses to the identified answers; and based on the comparison of the responses to the identified answers, provide at least one of the particular advertisements to the consumer.

As used herein, the term a “question” may be any data sent to a consumer that elicits a response (answer). For example, a question may be a text question prompting a yes or no response, a text question prompting a written response, a text question prompting the selection of multiple options, a text question prompting a consumer to move a slider, e.g., along a gradient of options, a text question prompting the consumer to select or upload an image, or a picture based question.

### BRIEF DESCRIPTION OF THE DRAWINGS

FIG. 1 is a flowchart of a method 100 of providing a targeted advertisement to a consumer according to an embodiment of the present invention.

FIG. 2 shows a question displayed as an overlay embedded on a web page according to an embodiment of the present invention.

FIG. 3 shows detail of an embedded question according to an embodiment of the present invention.

FIG. 4 is a block diagram illustrating the flow of information to and from a target identification system in order to provide targeted advertisements according to an embodiment of the present invention.

FIG. 5 is a block diagram illustrating the flow of information in order to provide targeted advertisements to a consumer using a cookie stored on an electronic device of the consumer according to an embodiment of the present invention.

FIG. 6 shows a block diagram of an exemplary computer apparatus usable with system and methods according to embodiments of the present invention.

### DETAILED DESCRIPTION OF EXEMPLARY EMBODIMENTS

Embodiments provide methods and systems that allow advertisers to custom define questions that are delivered to an electronic device of a consumer. After answering the questions, consumers may be shown advertisements based on their answers to one or more of the questions. For example, which ads to show a person may be determined based on specific answers to questions the person answered, where the questions are specifically related to the campaign with which the ad is associated.

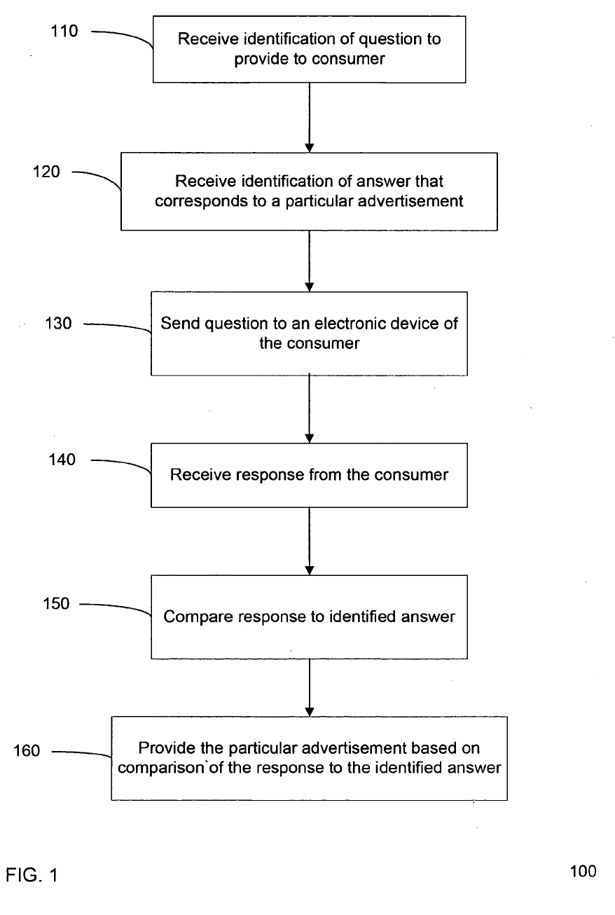

FIG. 1 is a flowchart of a method 100 of providing a targeted advertisement to a consumer according to an embodiment of the present invention. Unlike other advertisement targeting approaches that use extant (existing) consumer data to target advertisements, method 100 of proactive target identification method allows advertisers to define, up-front, questions to elicit a certain response and then base the advertisement on the response. This is in contrast to advertising methods that use a pre-existing database of information that has been passively collected about easily identifiable characteristics of a person, such as their age or their browsing habits.

In step 110, an advertiser identifies one or more questions to be provided to a consumer. The identification of the questions may be received at a target identification system. In one embodiment, the identification is achieved by sending the questions. For example, the advertiser can upload the questions to a server, e.g., of the target identification system. In another example, the advertiser may provide the questions through a server that is accessed via a link that is embedded in a web page, which by virtue of the link can be run as part of the target identification system. The link may be sent to the target identification system, which sends the link to the web page prior or during a rendering of the web page.

In another embodiment, the identification is achieved by selecting the questions from a list, e.g., provided on a setup page of a website associated with the target identification system. Thus, an advertiser may create the questions or select from a list of questions to be sent to the consumer. An advertiser may be a company specifically employed to run an ad campaign for another company or the company itself.

In step 120, the advertiser identifies one or more answers corresponding to a particular one or more advertisements that are to be provided to the consumer. The advertisements may be uploaded, or otherwise provided as described herein, at this time. In one embodiment, the correspondence between an answer(s) and an advertisement(s) is a simple one-to-one correspondence, such as a “Yes” answer corresponds to a particular advertisement or a group of advertisements from which one or more ads may be provided. In another embodiment, the correspondence is provided as part of a filtering mechanism that accounts for other data about the person, such as extant data.

In step 130, at least one of the identified questions is sent to an electronic device of a consumer. In one embodiment, the identified questions are sent to the electronic device when a request for a page from a website is received. In another embodiment, the web page may be downloaded to the electronic device, and then code in the web page may retrieve one of the questions, e.g. from a server maintained by the advertiser. In one aspect, this code for retrieving the questions is supplied by the target identification system. Thus, a processor of the electronic device may become part of and controlled by the target identification system.

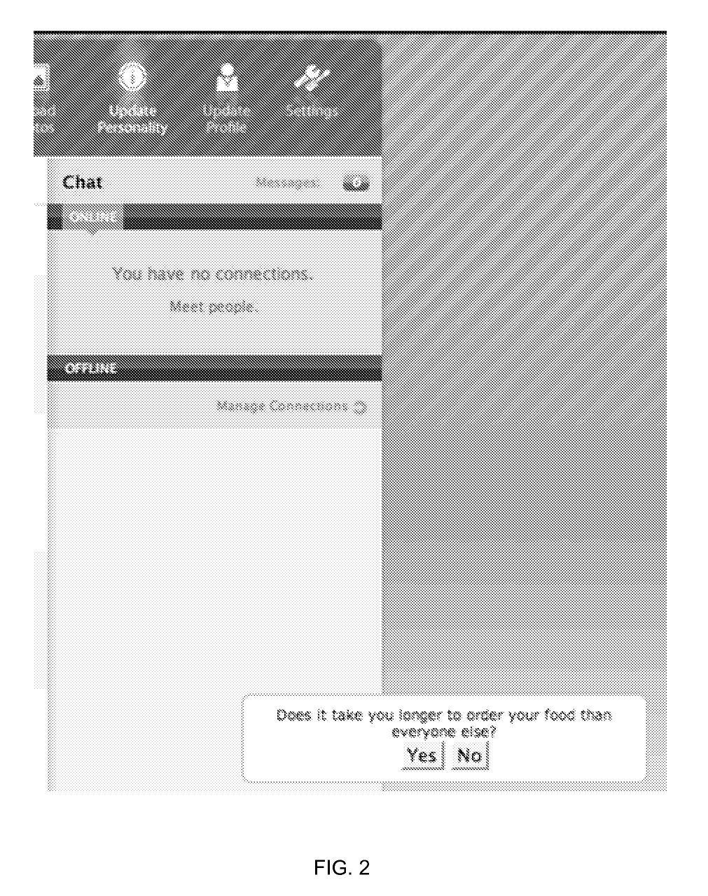

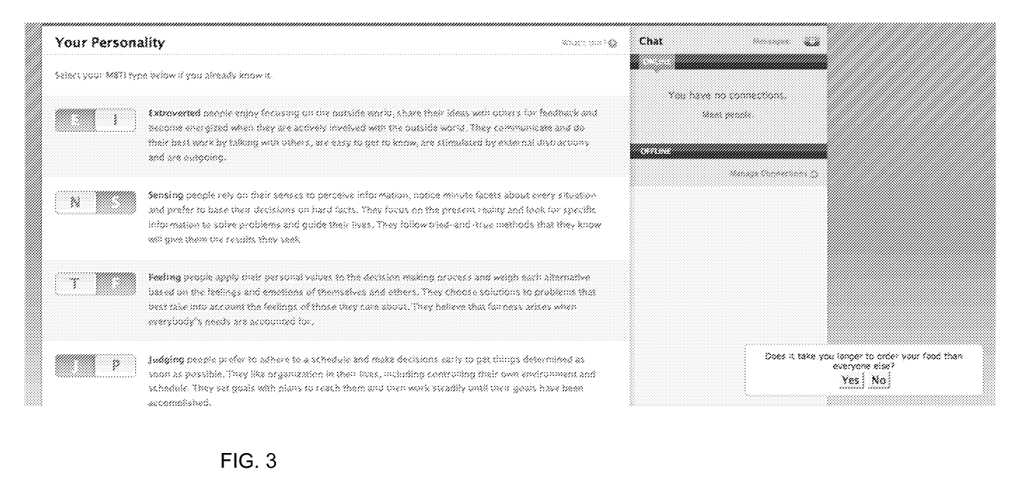

In one embodiment, the questions may be delivered to the consumers in real-time where the consumer is browsing other content, as in FIG. 2, or the questions may be given to a consumer in “survey” format, where answering the questions is the focus of the page. FIG. 3 shows an example where the questions are part of a personality test.

In step 140, one or more responses to the at least one question are received, e.g., at the target identification system from the consumer. In one embodiment, multiple responses are received for multiple questions. The responses may be left as is, or additional processing may be done to distill information from the answers. For example, when the response is written, the text may be parsed to determine the words used and their meaning, and then scores (e.g. number of times a word appears) or categorization of the response may be performed. The term “proactive targeting data” is used to describe any of this data. The term “response” includes any of the actual words of the response as well as data (such as proactive targeting data) derived therefrom.

In step 150, the responses are compared to the identified answers. The comparison may include whether or not an identical match occurs to one of the answers, e.g., a yes or no. The comparison may also include a similarity test based on any proactive targeting data, such that the response is found to be similar enough (e.g. a similarity score greater than a threshold) to the identified answers.

In step 160, at least one of the particular advertisements are provided to the consumer based on the comparison of the responses to the identified answers. In one embodiment, how long it took the consumer to answer the question and whether the consumer clicked on other content before answering the question can also be used to determine which advertisement to send to the consumer and if an advertisement is to be sent.

Ads can be displayed as static images and/or as multimedia animations and/or video elements. Content of the ad can also be customized based on the answer(s) to the question(s). The ads may also be sent via non-electronic methods, such as via regular mail.

In one embodiment, advertisers have the option of paying for advertisements that appear only if a consumer has answered a question, answered a question with a certain response, or answered a question in a certain way (e.g., how long it took the consumer to answer the question and whether the consumer clicked on other content before answering the question).

In another embodiment, a consumer must answer a certain way in order to be shown an advertisement. For example, the consumer must respond “yes.” As another example, the consumer must respond as “C” when the question provides multiple options to select as the response.

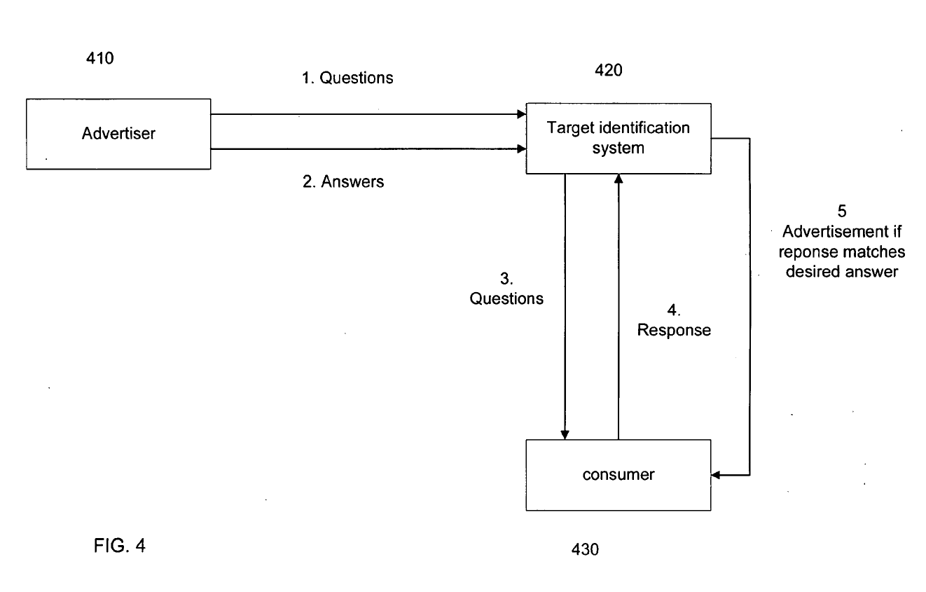

FIG. 4 is a block diagram illustrating the flow of information to and from a target identification system in order to provide targeted advertisements according to an embodiment of the present invention.

In act 1, the advertiser 410 sends an identification of one or more questions to the target identification system 420. For example, an advertiser 410 can create questions through a screen interface or by submitting them in writing or through digital transmission. The advertiser may also set up a server form which the questions may be received. The advertiser can then provide the location of the server to the target identification system 420, thus providing the identification. The location may be used by web pages running on any server or downloaded to a consumer's electronic device, such as a computer, netbook, phone, music player, etc.

In act 2, the advertiser 410 sends one or more answers to the target identification system 420. The advertiser 410 can also define specific advertisements to be displayed and choose the format of the display based on the answers to the questions. In one embodiment, advertisers can choose permutations of answers to multiple questions at their option, providing specific advertisements to show based on any permutation they choose.

In act 3, the questions are delivered to the consumer 430 by the target identification system 420. The target identification system 430 may include a website in which the consumer may be a member, has received a cookie, or otherwise signs up or agrees to be part of an ad program. When the consumer visits other websites, questions from the target identification system 430 may be sent to the other website and then to the consumer. Alternatively, the questions may be sent directly to the consumer. A browser or other software, which may be part of the target identification system 420, may be used to present the questions, for example, as an overlay or a pane on the web site currently being visited.

In some embodiments, the questions are stored at a central server associated with the target identification system 420. Thus, all of the questions may be stored at or associated with a website that the consumer is a member of.

In other embodiments, the questions are stored in a distributed fashion, e.g., with each question being stored at a server of a particular company or advertising entity. A requested page may then retrieve the questions from any of these places and embed the question in the page. In one aspect, the server providing the requested page, thus acts as the target identification system 420. In another aspect, the consumer's electronic device that assembles the content of the requested web page runs under control of the code of the requested web page, and is thus part of the target identification system 420.

In one embodiment, the requested page can query a known site to determine where to obtain the questions. For example, a requested page may contact the target identification system 420 to obtain a location (e.g. a server of the advertiser) from which to obtain the questions. The requested page would have code (e.g., obtained from the target identification system 420) that then directs a request to the target identification system 420 for the location of the question. Thus, the requested page is running as part of and/or under the control of the target identification system 420 regardless of which processor is actually assembling the content for the requested page. The consumer's electronic device or a server of a website that has signed up to provide targeted advertising may be the processor.

In act 4, the target identification system 420 then receives a response to the question. In one embodiment, the answers are stored at the target identification system. In another embodiment, the answers are stored in a distributed fashion, e.g., at servers associated with a particular company or advertising entity or at the consumer's electronic device. In yet another embodiment, the answers are stored at a client device of the consumer.

In act 5, advertisements are then displayed to the consumer based on the response to the question and/or to a set of responses to multiple questions. The answers may be compared to the responses to determine the advertisement to be sent. The identified answers may be stored, retrieved, or otherwise accessed in a similar manner as the questions. For example, the requested web page may contain a link to a location of the answers so that the web page (wherever it may be running) can access the answers and then send the data to an ad server. As another example, the answers may reside in a central repository, be retrieved, and then processed and/or sent to an ad server to determine the ad.

Advertisements shown in relation to the answers can be displayed on screen in many possible ways. For example, ads may be displayed in-line where the question was displayed on the screen immediately following the question being answered. For instance, after answering the question “Do you own more than 6 pairs of shoes?” the response “Thank you, sponsored by Nike” along with Nike logo and/or a link to the Nike web site may be displayed if the consumer answers “Yes”.

Advertisements may be shown on a screen to the consumer subsequent to their answering one or more questions in certain ways. For instance, display advertising, interstitial ads, or media-embedded ads can be selected at run-time based on the answers to the questions a consumer has provided in previous page requests or even previous sessions.

In one embodiment, at run-time, proactive target identification code would look at all possible ads that can be shown, then filter them based on the known answers to questions of the particular consumer. If the consumer has answered a particular set of questions that matches with an available ad, that ad will be displayed in the format appropriate to the consumer environment, including what kind of device the consumer is using, the screen resolution, and the context of the underlying content being viewed. The consumer may be identified by their login credentials or a cookie identifier associated with their consumer account.

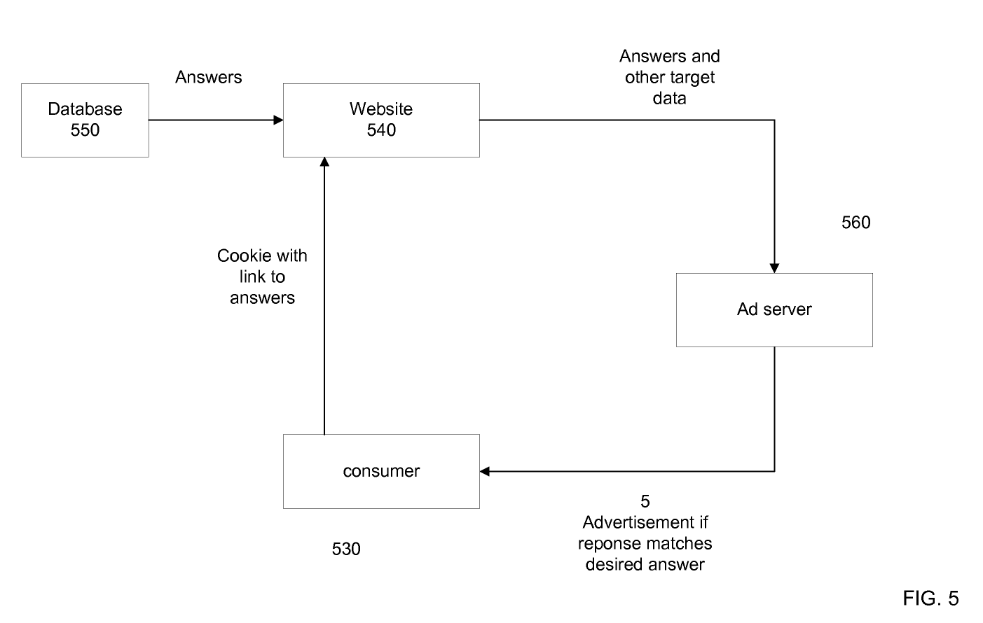

FIG. 5 is a block diagram illustrating the flow of information in order to provide targeted advertisements to a consumer using a cookie stored on an electronic device of the consumer according to an embodiment of the present invention. In one aspect, the requested page can use the cookie to obtain the answers or query a known site to determine where to obtain the answers.

Subsequent to the consumer answering a question, ads can be displayed on web sites other than the website that originally provided the questions and/or received information from the advertisers.

In one embodiment, where the ad is displayed on another web site 540, a cookie may be used to associate the consumer 530 to the responses that the consumer has previously given to the question(s), regardless of where those questions were displayed to the consumer.

In one aspect, the web site 540 may query a database 550, e.g., at the target identification system, in order to obtain either the answers and/or the targeted advertisement. These other websites would be running proactive targeting code to obtain the cookie and query the database, and thus are part of the target identification system.

In one embodiment, the web site 540 can then send the answers along with any target data (e.g. responses from the consumer) to an ad server 560, which is run in connection with or as part of the target identification system. The other target data may include an identification of the ads that are associated with particular answers, e.g., as identified by an advertiser, and may include targeting parameters, which include the proactive targeting data. The parameters can then be parsed by the ad server 560, and an ad is selected based on those parameters. In another embodiment, the ad server 560 may also receive the identification of the ads that are associated with particular answers directly from an advertiser.

The web site 540 (running as part of the target identification system 420) can also obtain the answers (e.g., if stored at the consumer device) from the consumer and then select an ad or send the answers along with any other target data to the ad server 560.

In an embodiment, in selecting an ad, proactive targeting data based on answers to one or more questions may be combined or not with existing data such as the gender, age, geographic location or other demographic or psychographic data known about the consumer. In another embodiment, content on the other website is identified, and the content may be used with the proactive targeting data to determine whether to display an ad on the other website and to determine the selecting of the ad.

In one example, if a consumer is visiting a web site, they are asked a question, “Do you ever go over your minutes on your phone each month?”. The consumer answers “Yes”. On a subsequent page request, the consumer is shown a banner ad for a mobile phone company that offers roll-over minutes.

In another example, a consumer visits a web site and is asked “Do you own a home” and answers “Yes”. On a subsequent request (e.g. a different web site; a pane, window, page, or updated view on the same web site; or from non-web content) the consumer is asked “Do you like your kitchen range?” and the consumer answers “No.” On a subsequent request the consumer is visiting another web site. That web site has embedded the code that can communicate with the originating web site of the questions, based on the answers to the two questions the consumer is shown an embedded video from a retailer of kitchen appliances detailing the benefits of a certain brand of kitchen ranges.

In one aspect, the embedding refers to the practice of displaying something to a person on a web page or other digital screen through inclusion of software code that makes a request for a remote resource. The rendering engine, such as a web browser or other display technology, takes the remotely retrieved software code and renders the appropriate visual representation, be it text, images, video or other digital artifact, to the person viewing the page on the screen. Along with the code, the remote request also uses the cookie mechanism that exists in web browsers to send the identifying information back to the server from which the remote software code is being requested. Such embedding is often referred to as a “widget” or an “embed” and is generally accomplished on the web with a SCRIPT or OBJECT or EMBED tag in HTML or similar mechanism in other software environments.

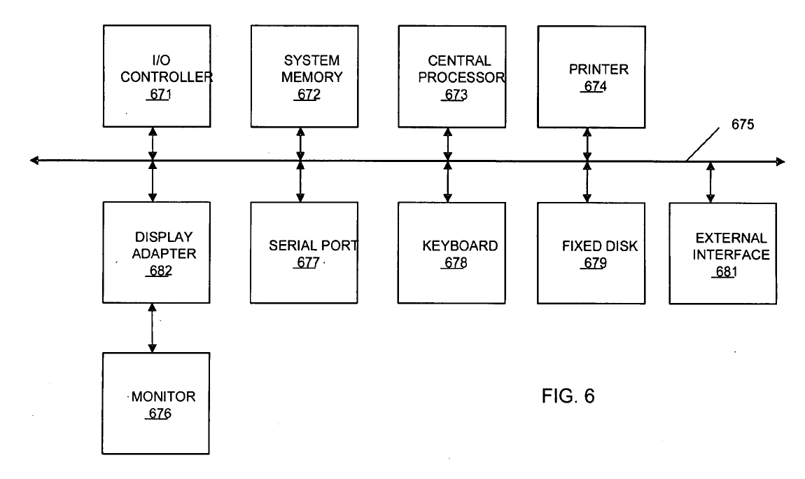

Any of the networks, systems, or devices described herein may utilize any suitable number of subsystems, each of which may be considered a separate device. Examples of such subsystems or components are shown in FIG. 6. The subsystems shown in FIG. 6 are interconnected via a system bus 675. Additional subsystems such as a printer 674, keyboard 678, fixed disk 679, monitor 676, which is coupled to display adapter 682, and others are shown. Peripherals and input/output (I/O) devices, which couple to I/O controller 671, can be connected to the computer system by any number of means known in the art, such as serial port 677. For example, serial port 677 or external interface 681 can be used to connect the computer apparatus to a wide area network such as the Internet, a mouse input device, or a scanner. The interconnection via system bus allows the central processor 673, which may include one or more processors, to communicate with each subsystem and to control the execution of instructions from system memory 672 or the fixed disk 679 (such as a hard drive or optical disk), as well as the exchange of information between subsystems. The system memory 672 and/or the fixed disk 679 may embody a computer readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++, Perl, PHP, or Python and also Javascript and ActionScript (which may be used exclusively on a client side), using, for example, conventional or object-oriented techniques. Computer programs incorporating features of the present invention may be encoded on various computer readable media for storage and/or transmission; suitable media include magnetic disk or tape, optical storage media such as compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer program product (e.g. a hard drive or an entire computer system), and may be present on or within different computer program products within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method of providing a targeted advertisement to a consumer, the method comprising:
receiving, at a target identification system from an advertiser, an identification of:
one or more questions to be provided to a consumer, and
one or more answers corresponding to a particular one or more advertisements that are to be provided to the consumer;
sending at least one of the identified questions from the target identification system to an electronic device of a consumer;
receiving, at the target identification system from the consumer, one or more responses to the at least one question;
comparing the responses to the identified answers; and
based on the comparison of the responses to the identified answers, providing at least one of the particular advertisements to the consumer.

2. The method of claim 1, wherein the identification is accomplished by providing a link to the questions.

3. The method of claim 1, further comprising:
retrieving a cookie from the electronic device of the consumer;
using the cookie to identify responses previously provided by the consumer; and
obtaining the responses for the comparison with the identified answers.

4. The method of claim 1, further comprising:
providing to the advertiser a list of questions, wherein the identification of the one or more questions includes a selection of at least one question from the list.

5. The method of claim 1, wherein the advertisement is provided to the electronic device of the consumer.

6. The method of claim 1, wherein the advertisement is provided to another device of the consumer.

7. The method of claim 1, wherein the advertisement is provided to the consumer only when the response satisfies one or more criteria.

8. The method of claim 7, wherein the criteria includes whether the answer is specifically one of several options provided in the question.

9. The method of claim 1, the at least one of the particular advertisements is provided to the consumer additionally based on existing data associated with the consumer.

10. A computer program product comprising a computer readable medium encoded with a plurality of instructions for controlling a processor to perform an operation for providing a targeted advertisement to a consumer, the instructions comprising:
receiving, at a target identification system from an advertiser, an identification of:
one or more questions to be provided to a consumer, and
one or more answers corresponding to a particular one or more advertisements that are to be provided to the consumer;
sending at least one of the identified questions from the target identification system to an electronic device of a consumer;
receiving, at the target identification system from the consumer, one or more responses to the at least one question;
comparing the responses to the identified answers; and
based on the comparison of the responses to the identified answers, providing at least one of the particular advertisements to the consumer.

11. A proactive target identification and advertising system comprising:
an interface that allows an advertiser to identify one or more questions to be provided to a consumer and one or more answers corresponding to a particular one or more advertisements that are to be provided to the consumer; and
one or more processors configured to:
send at least one of the identified questions from the target identification system to an electronic device of a consumer;
receive, at the target identification system from the consumer, one or more responses to the at least one question;
compare the responses to the identified answers; and
based on the comparison of the responses to the identified answers, provide at least one of the particular advertisements to the consumer.

12. The system of claim 11, wherein the least one of the particular advertisements is provided to the consumer electronically.

13. The system of claim 11, wherein the interface includes an option to upload the one or more questions.

14. The system of claim 11, wherein the interface includes an option to submit a link to the one or more questions.
